(19) United States
(12) Patent Application Publication
(10) Pub. No.: US 2026/0052048 A1
(43) Pub. Date: Feb. 19, 2026

(54) Dynamic Switching Between Different Number of Additional DMRS Symbols for PDSCH or PUSCH

(71) Applicant: Telefonaktiebolaget LM Ericsson (publ), Stockholm (SE)

(72) Inventors: Jianwei Zhang, Solna (SE); Andreas Nilsson, Göteborg (SE)

(21) Appl. No.: 19/102,779

(22) PCT Filed: Aug. 11, 2023
(86) PCT No.: PCT/EP2023/072309

§ 371 Date: Feb. 10, 2025

Related U.S. Application Data
(60) Provisional application No. 63/397,225, filed on Aug. 11, 2022.

(51) Int. Cl. H04L 27/26; H04L 5/00

(52) U.S. Cl. CPC H04L 27/261; H04L 5/0044

(57) ABSTRACT

The number of Demodulation Reference Signals (D.MRS) symbols (or DMRS density) for NR or 6G is dynamically adapted, using a list of configured candidate number of DMRS symbols (or DMRS density). Downlink Control Information (DCI) or Media Access Control (MAC) Control Elements (CE) are used to indicate one of the candidate numbers of DMRS symbols. Methods of adapting the D.MRS processing time for PDSCH scheduled with dynamic indication of number of D.MRS symbols are also disclosed.

### RELATED APPLICATIONS

This application claims the benefit of U.S. Provisional Application No. 63/397,225, filed 11 Aug. 2022, the entire disclosure of which being hereby incorporated by reference herein.

### TECHNICAL FIELD

The present disclosure relates generally to wireless communication networks, and in particular to dynamic switching between different numbers of additional Demodulation Reference Signal (DMRS) symbols for Physical Downlink or Uplink Shared Channels (PDSCH, PUSCH).

### BACKGROUND

Wireless communication networks are ubiquitous in many parts of the world. In one architecture, known as cellular networks, a plurality of generally fixed base stations (also known as radio base station, base station controller, Node-B, eNB, gNB, etc.) each provide wireless communication services to a large plurality of generally mobile wireless devices (also known as cellphones, smartphones, and more generally, User Equipment or UE). The base stations, with wireless links to UEs, form a Radio Access Network (RAN). The base stations in turn communicate (via wired or wireless links) to a Core Network (CN), which provides connectivity to further networks, such as the Internet.

Technical specifications developed and promulgated by standards bodies, such as the Third Generation Partnership Project (3GPP), govern operation of the networks, and ensure interoperability between equipment from different manufacturers. These standards continuously evolve to incorporate newly developed radio, computer, and networking technology, hence increasing the volume and quality of data transfer, and supporting new use cases. The fourth generation (4G) wireless protocol, known as Long Term Evolution (LTE) has been deployed, and the fifth generation (5G), known as New Radio (NR), is in advanced development and early deployment. On a finer granularity, 3GPP technical standards advance by numbered Releases (e.g., Rel-14, Rel-15, etc.).

Wireless communication signals are altered by the channel across which they are transmitted (e.g., the air interface between gNB and UE). To assess the channel, reference signals (RS) have long been a part of wireless communications protocols. RS are data patterns that are known a priori to both the transmitter and receiver. By comparing received and decoded RS with the known RS data pattern. a receiver can characterize the channel, and use that knowledge to more accurately decode received data signals. Various types of RS are defined. and are used in different situations. Because the channel is dynamic. RS are periodically transmitted in both Downlink (DL) and Uplink (UL) directions.

One type of RS is the Demodulation RS (DMRS). DMRS is transmitted on physical channels (e.g., Physical Broadcast Channel (PBCH) and physical control and shared channels in both the uplink and downlink directions (PUCCH, PUSCH. PDCCH and PDSCH). DMRS is important to support several types of Multiple Input. Multiple Output (MIMO) techniques that increase channel capacity and improve data rates (e.g., spatial diversity. spatial multiplexing, and beamforming).

NR Rel-18 aims to improve MIMO performances in several areas, including uplink performance; Multi-User (MU)-MIMO performance; and better support for middle/high velocity UEs. Different numbers of additional DMRS symbols for PDSCH and PUSCH can be an essential function to enhance the performance in all these areas. In existing NR technology, a different number of additional DRMS symbols can only be configured via Radio Resource Control (RRC) reconfiguration, a high-layer signaling protocol. This means that UL/DL data transmission is interrupted when the UE velocity is changed. Also, the resources used to enable the UE to use different numbers of additional DMRS symbols cannot be used to co-schedule other UEs.

U.S. Provisional Patent Application Ser. No. 63/336,813, filed April 29. 2022, titled “Dynamic Switching Between Legacy and Advanced DMRS Protocols.” the disclosure of which is incorporated herein by reference in its entirety, provides one possible way to configure and dynamically indicate a different number of DMRS symbols by utilizing a bit in DCI.

Dynamic indication of the number of DMRS symbols in the NR specification is beneficial for adapting the DMRS overhead vs. channel estimation performance, depending on UE speed. In Rel-18. 3GPP will specify support for UEs to report time domain correlation parameters that can be used to estimate the UE speeds. Based on this information, the precoding schemes. DMRS configuration, etc., can be adapted. However, to utilize this, it is important that the relevant configurations can be dynamically updated in an overhead-efficient way. Hence, in Rel-18 and future releases of NR, it is expected that more flexible solutions will be specified to utilize the reporting of time domain correlation parameters by introducing more dynamic and flexible updates of configurations that depend on the UE speed.

In addition, for 5G advance and 6G, Artificial Intelligence/Machine Learning (AI/ML) based solutions will be specified to optimize the performance in the networks even further. In order to utilize AI/ML based solutions, it will be necessary to have a framework that enables dynamic and overhead efficient configurations of UEs. For example, the AI/ML algorithm might determine, based on received UL reference signals, an optimal number of DMRS symbols to use for a particular UE. However, due to non-flexible configurations of the number of DMRS symbols (which is the case in current NR specification), the AI/ML based models might not be able to be utilized to their full potential. Hence, there is a need to improve the flexibility for more dynamic DMRS configurations.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to aspects of the present disclosure described and claimed herein, the number of DMRS symbols (or DMRS density) for NR or 6G is dynamically adapted, using a list of configured candidate number of DMRS symbols (or DMRS density). Downlink Control Information (DCI) or Media Access Control (MAC) Control Elements (CE) are used to indicate one of the candidate numbers of DMRS symbols. The disclosure also describes methods of adapting the DMRS processing time for PDSCH scheduled with dynamic indication of number of DMRS symbols.

One aspect relates to a method, performed by a wireless device operative in a wireless communication network. The network is informed of a capability to support at least one of dynamic switching of a number of additional DMRS, and dynamic switching of DMRS time density. One of a configuration of a set of candidate number of additional DMRS and a configuration of a candidate number of DMRS time densities is received from the network. An indication of one of the set of candidate number of additional DMRS or one of the set of candidate number of DMRS time densities is received from the network in a DCI or MAC CE. DMRS are received and processed according the indicated one of the set of candidate number of additional DMRS or the indicated one of the set of candidate number of DMRS time densities.

Another aspect relates to a wireless device operative in a wireless communication network. The wireless device includes communication circuitry configured to communicate with one or more network nodes, and processing circuitry operatively connected to the communication circuitry. The processing circuitry is configured to inform the network of a capability to support at least one of dynamic switching of a number of additional Demodulation Reference Symbols (DMRS) and dynamic switching of DMRS time density; receive, from the network, one of a configuration of a set of candidate number of additional DMRS and a configuration of a candidate number of DMRS time densities; receive, from the network in a Downlink Control Information (DCI) or Media Access Control (MAC) Control Element (CE) an indication of one of the set of candidate number of additional DMRS or one of the set of candidate number of DMRS time densities; and receive and process DMRS according the indicated one of the set of candidate number of additional DMRS or the indicated one of the set of candidate number of DMRS time densities.

Yet another aspect relates to a method, performed by a base station operative in a wireless communication network. An indication of a capability of the wireless device to support at least one of dynamic switching of a number of additional Demodulation Reference Symbols (DMRS), and dynamic switching of DMRS time density is received from a wireless device. One of a configuration of a set of candidate number of additional DMRS and a configuration of a candidate number of DMRS time densities is sent to the wireless device. An indication of one of the set of candidate number of additional DMRS or one of the set of candidate number of DMRS time densities is sent to the wireless device in a Downlink Control Information (DCI) or Media Access Control (MAC) Control Element (CE). DMRS are transmitted according the indicated one of the set of candidate number of additional DMRS or the indicated one of the set of candidate number of DMRS time densities.

Still another aspect relates to a base station operative in a wireless communication network. The base station includes communication circuitry configured to communicate with one or more wireless devices, and processing circuitry operatively connected to the communication circuitry. The processing circuitry is configured to receive, from a wireless device, an indication of a capability of the wireless device to support at least one of dynamic switching of a number of additional Demodulation Reference Symbols (DMRS) and dynamic switching of DMRS time density; send, to the wireless device, one of a configuration of a set of candidate number of additional DMRS and a configuration of a candidate number of DMRS time densities; send, to the wireless device in a Downlink Control Information (DCI) or Media Access Control (MAC) Control Element (CE) an indication of one of the set of candidate number of additional DMRS or one of the set of candidate number of DMRS time densities; and transmit DMRS according the indicated one of the set of candidate number of additional DMRS or the indicated one of the set of candidate number of DMRS time densities.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a time diagram of a PDCCH and PDSCH over one slot.

FIG. 2 shows two time/frequency diagrams showing a Resource Element and a Resource Block.

FIG. 3A is a time/frequency diagram showing type-1 single-symbol DMRS.

FIG. 3B is a time/frequency diagram showing type-1 double-symbol DMRS.

FIG. 3C is a time/frequency diagram showing type-2 single-symbol DMRS.

FIG. 3D is a time/frequency diagram showing type-2 double-symbol DMRS.

FIG. 4 is a time diagram showing DMRS repetitions.

FIG. 5 is a time diagram showing DMRS configurations for PDSCH.

FIG. 6 is a graph showing Cross over points as a function of speed.

FIG. 7 is a pseudo-code listing showing a conventional PDSCH-Config Information Element (IE).

FIG. 8 is a pseudo-code listing showing a conventional DMRS-DownlinkConfig 1E.

FIG. 9 is a pseudo-code listing showing a conventional PUSCH-Config IE.

FIG. 10 is a pseudo-code listing showing a conventional DMRS-UplinkConfig IE.

FIG. 11 is a flow diagram of a method performed by a wireless device.

FIG. 12 is a flow diagram of a method performed by a base station.

FIG. 13 is a hardware block diagram of a wireless device.

FIG. 14 is a functional block diagram of a wireless device.

FIG. 15 is a hardware block diagram of a network node.

FIG. 16 is a functional block diagram of a network node.

FIG. 17 is a pseudo-code listing showing an inventive DMRS-UplinkConfig IE.

FIG. 18 is a pseudo-code listing showing an inventive DMRS-DownlinkConfig IE.

FIG. 19A is a pseudo-code listing showing the first part of an inventive PUSCH-TimeDomainResourceAllocation IE.

FIG. 19B is a pseudo-code listing showing the second part of the inventive PUSCH-TimeDomainResourceAllocation IE of FIG. 19A.

FIG. 20 is a pseudo-code listing showing an inventive PDSCH-TimeDomainResourceAllocationList IE.

FIG. 21 is a diagram of a communication system.

FIG. 22 is a block diagram of a UE.

FIG. 23 is a block diagram of a network node.

FIG. 24 is a block diagram of a host device.

FIG. 25 is block diagram of a virtualization environment.

FIG. 26 is a block diagram of a UE communicating with a host via a wireless network.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

### NR Frame Structure and Resource Grid

NR uses CP-OFDM (Cyclic Prefix Orthogonal Frequency Division Multiplexing) in both downlink (i.e. from a network node, gNB, or base station, to a user equipment or UE) and uplink (i.e. from UE to gNB). DFT spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Af=15 kHz, there is only one slot per subframe and each slot consists of 14 OFDM symbols.

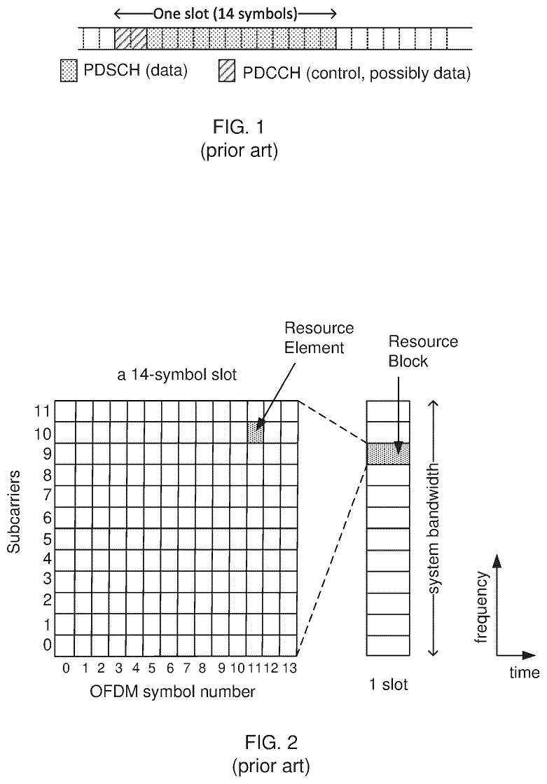

Data scheduling in NR is typically in slot basis (an example is shown in FIG. 1, with a 14-symbol slot) where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2\hat{ }μ) kHz where μ∈0), 1,2,3,4. Δf=15 kHz is the basic subcarrier spacing. The slot durations at different subcarrier spacings is given by 1/2\hat{ }μ ms.

In the frequency domain, a system bandwidth is divided into resource blocks (RBs), each corresponding to 12 contiguous subcarriers. The RBs are numbered starting with 0) from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE). Downlink (DL) PDSCH transmissions can be either dynamically scheduled, i.e., in each slot the gNB transmits downlink control information (DCI) over PDCCH (Physical Downlink Control Channel) about which UE data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, uplink (UL) PUSCH transmission can also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0)_1, and DCI format ( ) 2.

DMRS configuration

Demodulation reference signals (DMRS) are used for coherent demodulation of physical layer data channels, i.e., Physical Downlink Shared Channel (PDSCH) and Physical Uplink Shared Channel (PUSCH), as well as of Physical Downlink Control Channel (PDCCH). The DMRS is confined to resource blocks carrying the associated physical layer channel and is mapped on allocated resource elements of the time-frequency resource grid such that the receiver can efficiently handle time/frequency-selective fading radio channels.

The mapping of DMRS to resource elements is configurable in both frequency and time domain. There are two mapping types in the frequency domain. i.e., type 1 and type 2. In addition, there are two mapping types in the time domain. i.e., mapping type A and type B, which defines the symbol position of the first OFDM symbol containing DMRS within a transmission interval.

The DMRS mapping in time domain can further be single-symbol based or double-symbol based, where the latter means that DMRS is mapped in pairs of two adjacent OFDM symbols. For single symbol based DMRS, a UE can be configured with one, two, three, or four single-symbol DMRS (also referred to as additional DMRS) in a slot. For double-symbol based DMRS, a UE can be configured with one or two such double-symbol DMRS in a slot. In scenarios with low Doppler, it may be sufficient to configure front-loaded DMRS only. i.e. one single-symbol DMRS or one double-symbol DMRS, whereas in scenarios with high Doppler additional DMRS will be required in a slot.

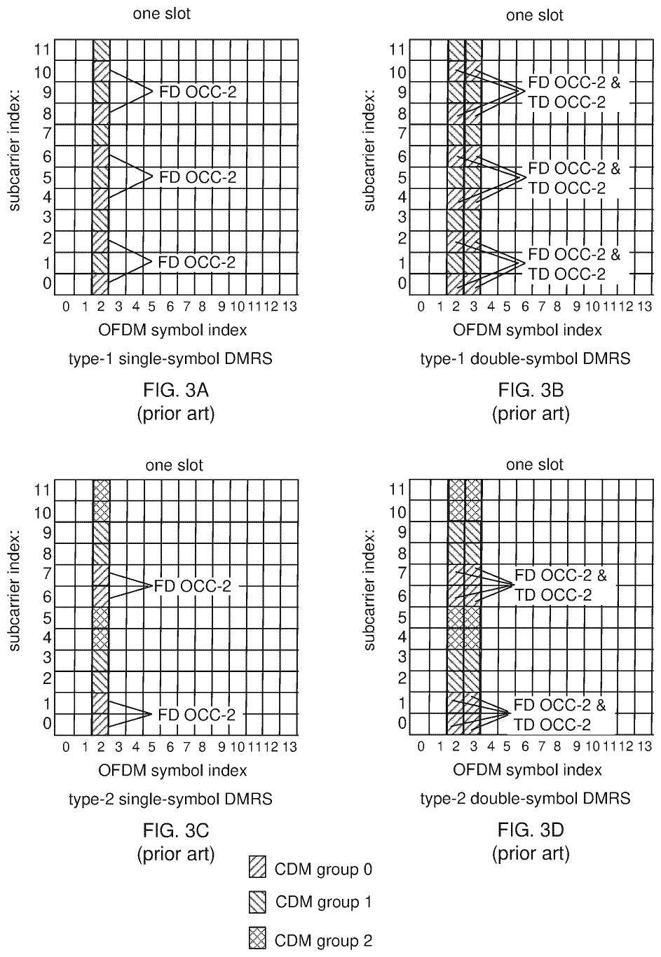

FIGS. 3A-D show front-loaded DMRS for configuration type 1 and type 2 single-and double-symbol DMRS where different CDM groups indicated by different hatching patterns. In particular. FIGS. 3A and 3B show examples of type 1 front-loaded DMRS with single-symbol (FIG. 3A) and double-symbol (FIG. 3B) DMRS and time domain mapping type A with first DMRS in the third OFDM symbol of a transmission interval of 14 symbols. FIGS. 3C and 3D show examples of type 2 front-loaded DMRS with single-symbol (FIG. 3C) and double-symbol (FIG. 3D) DMRS and time domain mapping type A with first DMRS in the third OFDM symbol of a transmission interval of 14 symbols. One observes from these FIGS. 3A-D that type 1 and type 2 differ with respect to both the mapping structure and the number of supported DMRS CDM groups, where type 1 support 2 CDM groups and Type 2 support 3 CDM groups.

A DMRS antenna port is mapped to the resource elements within one CDM group only. For single-symbol DMRS, two antenna ports can be mapped to each CDM group whereas for double-symbol DMRS four antenna ports can be mapped to each CDM group. Hence, for DMRS type 1 the maximum number of DMRS ports is four for a single-symbol based DMRS configuration and eight for double-symbol based DMRS configuration. For DMRS type 2, the maximum number of DMRS ports is six for a single-symbol based DMRS configuration and twelve for double-symbol based DMRS configuration.

An orthogonal cover code (OCC) of length 2 (i, e., [+1, +1] or [+1,−1]) is used to separate antenna ports mapped in the same two resource elements within a CDM group. The OCC is applied in frequency domain (FD) as well as in time domain (TD) when double-symbol DMRS is configured. This is illustrated in FIG. 3 for CDM group 0.

In NR Rel-15, the mapping of a PDSCH DMRS sequence r (m), m=0,1, . . . on antenna port p and subcarrier k in OFDM symbol l for the numerology index u is specified in 3GPP TS 38.211 as

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

where w_{f}(k′) represents a frequency domain length 2 OCC code and wₜ(l′) represents a time domain length 2 OCC code. Table 1 and Table 2 show the PDSCH DMRS mapping parameters for configuration type 1 and type 2, respectively.

TABLE 1
PDSCH DMRS mapping parameters for configuration type 1.

| | | |
|---|---|---|
| CDM | | |
| group | w_{f} (k′) | wₜ (l′) |

| p | λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DMRS mapping parameters for configuration type 2.

| | | |
|---|---|---|
| CDM | | |
| group | w_{f} (k′) | wₜ (l′) |

| p | λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

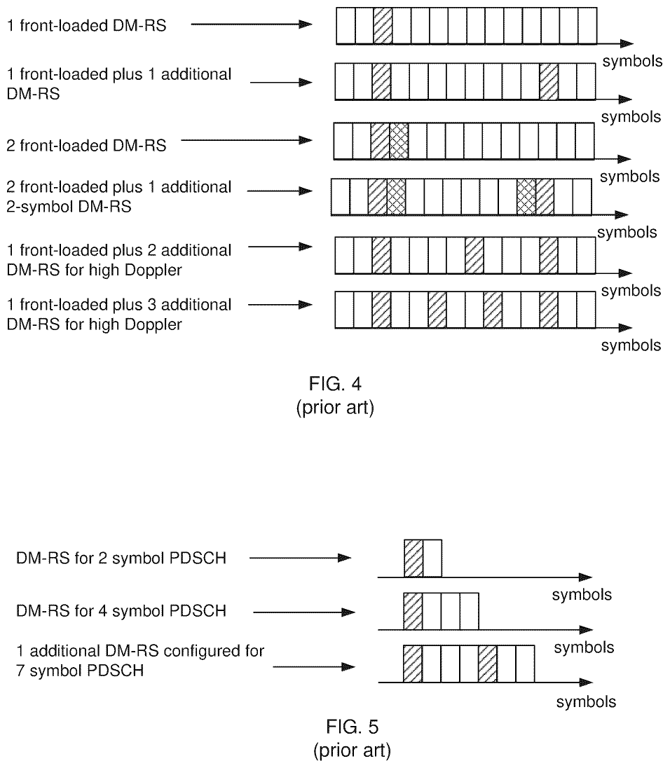

For PDSCH mapping type A, DMRS mapping is relative to slot boundary. That is, the first front-loaded DMRS symbol in DMRS mapping type A is in either the 3^{rd} or 4^{th} symbol of the slot. In addition to the front-loaded DMRS, type A DMRS mapping can consist of up to 3 additional DMRS. Some examples of DMRS for mapping type A are shown in FIG. 4 (note that PDSCH length of 14 symbols is assumed in the examples).

For PDSCH mapping type B, DMRS mapping is relative to transmission start. That is, the first DMRS symbol in DMRS mapping type B is in the first symbol in which type B PDSCH starts. Some examples of DMRS for mapping type A are shown in FIG. 5.

The same DMRS design for PDSCH is also applicable for PUSCH when transform precoding is not enabled, where the sequence r (m) shall be mapped to the intermediate quantity

$${\tilde{a}}_{k , l}^{( {\tilde{p}}_{j} , μ )}$$

for DMRS port \tilde{p}ⱼ according to

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , v - 1$$

where w_{f}(k′), wₜ(l′), and Δ are given by Tables 6.4.1.1.3-1 and 6.4.1.1.3-2 in TS38.211, which are reproduced below, and v is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

shall be precoded, multiplied with the amplitude scaling factor

$${β}_{PUSCH}^{DMRS}$$

in order to conform to the transmit power specified in clause 6.2.2 of TS 38.214, and mapped to physical resources according to

$$[ \begin{matrix}{a}_{k , l}^{( {p}_{0} , μ )} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{0} , μ )} \\ ⋮ \\ {\tilde{a}}_{k , l}^{( {\tilde{p}}_{v - 1} , μ )}\end{matrix} ]$$

where
the precoding matrix W is given by clause 6.3.1.5 of TS38.211,
{P₀, . . . , Pₚ₋₁} is a set of physical antenna ports used for transmitting the PUSCH, and
{\tilde{P}₀, . . . , \tilde{P}ᵥ₋₁} is a set of DMRS ports for the PUSCH;

TABLE 6.4.1.1.3-1
Parameters for PUSCH DMRS configuration type 1.

| | | |
|---|---|---|
| CDM | | |
| group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 6.4.1.1.3-2
Parameters for PUSCH DMRS configuration type 2.

| | | |
|---|---|---|
| CDM | | |
| group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

DMRS Sequence generation

The DMRS sequence r(n) for both PDSCH and PUSCH is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c (i) is defined in clause 5.2.1 of 3gpp 38.211. The pseudo-random sequence generator is initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame, and
For PDSCH DMRS,

$${N}_{ID}^{0} , {N}_{ID}^{1} ∈ \{ 0 , 1 , ... , 65535 \}$$

are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI;
For PUSCH DMRS,

$${N}_{ID}^{0} , {N}_{ID}^{1} ∈ \{ 0 , 1 , ... , 65535 \}$$

are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant:

$${N}_{ID}^{0} , {N}_{ID}^{1} ∈ \{ 0 , 1 , ... , 65535 \}$$

configuration, given by the higher-layer parameters msgA-ScramblingID0 and msgA-ScramblingID1, respectively, in the msgA-DMRS-Config IE if provided and the PUSCH transmission is triggered by a Type-2 random access:
For PDSCH DMRS,

$${N}_{ID}^{0} ∈ \{ 0 , 1 , ... , 65535 \}$$

is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI:
For PUSCH DMRS,

$${N}_{ID}^{0} ∈ \{ 0 , 1 , ... , 65535 \}$$

is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI;

$${N}_{ID}^{{\overline{n}}_{SCID}^{\overline{λ}}} = {N}_{ID}^{cell}$$

otherwise:

$${\overline{n}}_{SCID}^{\overline{λ}}$$

and λ̅ are given by
if the higher-layer parameter dmrs-Downlink in the DMRS-DownlinkConfig IE or dmrs-Uplink in the DMRS-UplinkConfig IE is provided, the corresponding

$${\overline{n}}_{SCID}^{\overline{λ}}$$

and λ̅ are determined as

$${\overline{n}}_{SCID}^{\overline{λ}} = \{ \begin{matrix}{n}_{SCID} & λ = 0 or λ = 2 \\ 1 - {n}_{SCID} & λ = 1\end{matrix}$$

$$\overline{λ} = λ$$

where λ is the CDM group index.
otherwise by

$${\overline{n}}_{SCID}^{\overline{λ}} = {n}_{SCID}$$

$$\overline{λ} = 0.$$

The quantity n_{SCID} ∈{0, 1} is given by the DMRS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a configured grant; otherwise n_{SCID}=0.

DMRS ports signaling

DMRS port(s) for a PDSCH or a PUSCH are signaled in the corresponding scheduling DCI. In addition to the DMRS ports, the number of CDM groups that are not allocated for PDSCH or PUSCH and also the number of front-loaded DMRS symbols are dynamically signaled in the DCI.

“Antenna port” field in DCI 1_1 is defined as following in 3GPP TS 38.212:
Antenna port(s)-4, 5, or 6 bits as defined by Tables 7.3.1.2.2-1/2/3/4 and Tables 7.3.1.2.2-1A/2A/3A/4A, where the number of CDM groups without data of values 1, 2, and 3 refers to CDM groups {0}, {0,1}, and {0, 1,2} respectively. The antenna ports {p₀, . . . , pᵥ₋₁} shall be determined according to the ordering of DMRS port(s) given by Tables 7.3.1.2.2-1/2/3/4 or Tables 7.3.1.2.2-1A/2A/3A/4A. When a UE receives an activation command that maps at least one codepoint of DCI field ‘Transmission Configuration Indication’ to two TCI states, the UE shall use Table 7.3.1.2.2-1A/2A/3A/4A; otherwise, it shall use Tables 7.3.1.2.2-1/2/3/4. The UE can receive an entry with DMRS ports equals to 1000, 1002, 1003 when two TCI states are indicated in a codepoint of DCI field ‘Transmission Configuration Indication’.

If a UE is configured with both dmrs-DownlinkForPDSCH-MappingTypeA and dmrs-DownlinkForPDSCH-MappingTypeB, the bitwidth of this field equals max {x_{A}, x_{B}}, where X_{A} is the “Antenna ports” bitwidth derived according to dmrs-DownlinkForPDSCH-MappingTypeA and x_{B} is the “Antenna ports” bitwidth derived according to dmrs-DownlinkForPDSCH-MappingTypeB. A number of |X_{A}-X_{B} | zeros are padded in the MSB of this field, if the mapping type of the PDSCH corresponds to the smaller value of X_{A} and X_{B}.

“Antenna port” field in DCI 1_2 and DCI 0_2 is 0 bit if higher layer parameter, antennaPortsFieldPresentDCI-1-2 and antennaPortsFieldPresenceDCI-O-2 respectively, is not configured. The antenna port(s) are defined assuming bit field index value 0 in Tables 7.3.1.2.2-1/2/3/4 for DCI 1_2 and 7.3.1.1.2-6 to 7.3.1.1.2-23 for DCI 0_2.

In PUSCH scheduling, the number of layers are indicated separately from DMRS ports signaling in the DCI. While for PDSCH scheduling, the number of layers and DMRS ports are signaled jointly in the DCI.

An “antenna port(s)” bit field in DCI is used for the purpose. An example for type 1 DMRS with rank=1 and up to two maximum number of front-loaded DMRS OFDM symbols for PUSCH is shown in Table 7.3.1.1.2-12 below, which is copied from 3gpp TS 38.212. Here 4bits are used for the bitwidth of the ‘antenna port(s)’ field. Note that DMRS type and maximum number of front-loaded DMRS symbols are semi-statically configured by RRC.

TABLE 7.3.1.1.2-12
Antenna port(s), transform precoder is disabled, dmrs-Type = 1,
maxLength = 2, rank = 1 (from TS38.212 of 3gpp)

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Another example for type 1 DMRS with up to two maximum number of front-loaded DMRS OFDM symbols for PDSCH is shown in Table 7.3.1.2.2-2 below, which is copied from 3GPP TS 38.212.

TABLE 7.3.1.2.2-2
Antenna port(s) (1000 + DMRS port), dmrs-Type =
1, maxLength = 2 (from TS 38.212 of 3GPP)

| One Codeword: | | | | | | | |
|---|---|---|---|---|---|---|---|
| Codeword 0 enabled, | | | | Two Codewords: | | | |
| Codeword 1 disabled | | | | Codeword 0 enabled, | | | |
| | Number | | | Codeword 1 enabled | | | |
| | of DMRS | | | | Number of | | |
| | CDM | | Number | | DMRS CDM | | |
| | group(s) | | of front- | | group(s) | | Number of |
| | without | DMRS | load | | without | DMRS | front-load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In Rel-16 M-TRP PDSCH, a new row with indices value 31 is added to existing antenna port table. When MACCE activates any of the TCI field codepoint associated with 2 TCI states, the table containing the new row is used to indicate which of the ports are used for PDSCH for each TRP.

TABLE 7.3.1.2.2-2A
Antenna port(s) (1000 + DMRS port), dmrs-Type =
1, maxLength = 2 (from TS38.212 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS | | | | DMRS | | |
| | CDM | | Number | | CDM | | Number |
| | group(s) | | of front- | | group(s) | | of front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

### DCI 1_0, DCI 0_0

DCI 1_0 is fallback DCI for downlink, DCI 0_0 is fallback DCI for uplink. It is 5 specified in NR that DCI 1_0 applies only the Type 1 DMRS, because DCI 1_0 can be used to signal paging message and system information which are broadcasted for all UEs. While DCI 0_0 can apply either Type 1 or Type2, whichever is the configured DMRS type as in DMRS-Config under PUSCH-Config or configuredGrantConfig from UE specific signaling.

SU-MIMO and Co-scheduling of UE in the downlink

For the antenna port tables defined for each DMRS types, some of the indices are specified to be used only for SU-MIMO. For remaining indices that can be used for MU-MIMO, the UE assumes the co-scheduled UE are scheduled with same DMRS-type and same number of DMRS symbols.

For DMRS configuration type 1,
if a UE is scheduled with one codeword and assigned with the antenna port mapping with indices of {2, 9, 10, 11 or 30} in Table 7.3.1.2.2-1 and Table 7.3.1.2.2-2 of Clause 7.3.1.2 of [5, TS 38.212], or
if a UE is scheduled with one codeword and assigned with the antenna port mapping with indices of {2, 9, 10, 11 or 12} in Table 7.3.1.2.2-1A and {2, 9, 10, 11, 30 or 31} in Table 7.3.1.2.2-2A of Clause 7.3.1.2 of [5, TS 38.212], or
if a UE is scheduled with two codewords, the UE may assume that all the remaining orthogonal antenna ports are not associated with transmission of PDSCH to another UE.

For DMRS configuration type 2,
if a UE is scheduled with one codeword and assigned with the antenna port mapping with indices of {2, 10 or 23} in Table 7.3.1.2.2-3 and Table 7.3.1.2.2-4 of Clause 7.3.1.2 of [5, TS38.212], or
if a UE is scheduled with one codeword and assigned with the antenna port mapping with indices of {2, 10, 23 or 24} in Table 7.3.1.2.2-3A and {2, 10, 23 or 58} in Table 7.3.1.2.2-4A of Clause 7.3.1.2 of [5, TS 38.212], or
if a UE is scheduled with two codewords, the UE may assume that all the remaining orthogonal antenna ports are not associated with transmission of PDSCH to another UE.
   Usage of different number of additional DMRS symbols

Different number of additional DMRS symbols are typically used to support different UE velocity or different frequency offset within a slot.

In Rel-15 when maxlen equals 2, 1 or 2 frontloaded DMRS symbols can be indicated to the UE.

However, in a real network, 2 frontloaded DMRS symbols are seldom used due to the large overhead. In a real network UE may frequently change its velocity, different number of additional DMRS symbols are thus appropriate to be used. For low velocity, 0 or 1 additional DMRS symbols can be used, for velocity higher than 50 km/h, 1 or 2 additional DMRS symbols shall be used. For Rel-18 DMRS enhancement, co-existence of multiple UEs with same velocity can further get supported to utilize the enhanced velocity reporting aiming medium and high speed UEs.

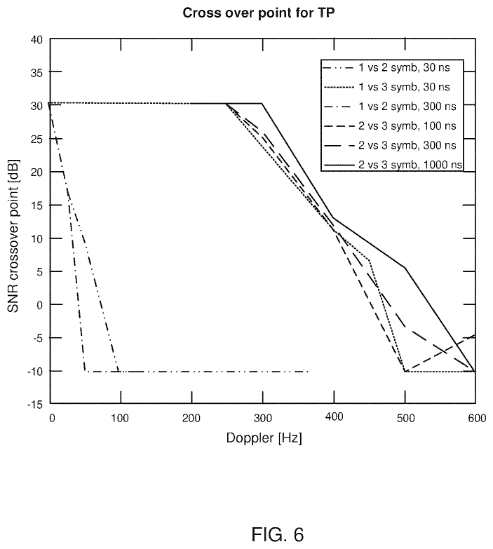

FIG. 6 is an aggregate of many simulation results showing how this crossover point in SNR depends on the Doppler spread. From the figure one can see a quite rapid change in the crossover point between a pure front loaded DMRS to a 1+1 pattern (i.e., zero additional or one additional, denoted by “1 vs 2 symb” in the figure) for increasing Doppler. This crossover point changes significantly just by increasing the Doppler from 5 Hz to 25 Hz.

When comparing DMRS of the 1+1 pattern to the 1+1+1 pattern (denoted by “2 vs 3 symb” in the figure), one can see that the 1+1+1 pattern starts to become beneficial from around 250 Hz Doppler. From around 500 Hz doppler the 1+1+1 pattern is beneficial even at low SNR, i.e. at high enough speeds the 1+1+1 pattern is beneficial for all SNR.

The above results are all for 15 kHz subcarrier spacing. If the subcarrier spacing is increased to 30 KHz then the time duration of the slot is halved. This translates to roughly a doubling of the Doppler spread value which can be supported by a specific DMRS configuration. For example, the crossover between 2 and 3 symbols of DMRS starts to take effect at 250 Hz Doppler spread for 15 kHz subcarrier spacing, and for 30 kHz subcarrier spacing this effect instead starts to be visible at 500 Hz Doppler spread.

Aspects related to additionalDMRSPosition

According to UE DMRS transmission procedure in NR, the number of configurable additional DMRS positions is related to the maxLen configuration for PUSCH and PDSCH (38.214 5.1.6.2, 6.2.2). When maxLen is set to ‘len1’, single DMRS can be scheduled or activated for UE by DCI, additional DMRS position can be configured as ‘pos0’, ‘pos1’,′pos2′ or ‘pos3’; when maxLen is set to ‘len2’, single DMRS or double DMRS can be scheduled or activated for UE by DCI, additional DMRS position can be set to ‘post’, ‘pos1’.

In Rel-15 to Rel-17, different additional position configuration will result in different PDSCH processing time for UE configured with capability 1.

TABLE 5.3-1
PDSCH processing time for PDSCH processing capability 1

| | PDSCH decoding time N₁ [symbols] | |
|---|---|---|
| | dmrs-AdditionalPosition = ‘pos0’ | |
| | in DMRS-DownlinkConfig in | dmrs-AdditionalPosition ≠ ‘pos0’ |
| | dmrs-DownlinkForPDSCH- | in DMRS-DownlinkConfig in any of |
| | MappingTypeA and dmrs- | dmrs-DownlinkForPDSCH- |
| | DownlinkForPDSCH-MappingTypeB | MappingTypeA, dmrs- |
| | if either higher layer parameter | DownlinkForPDSCH-MappingTypeB, |
| | is configured, and in dmrs- | dmrs-DownlinkForPDSCH- |
| | DownlinkForPDSCH-MappingTypeA- | MappingTypeA-DCI-1-2, dmrs- |
| | DCI-1-2 and dmrs-DownlinkForPDSCH- | DownlinkForPDSCH-MappingTypeB- |
| | MappingTypeB-DCI-1-2 if either | DCI-1-2,or if none of the higher |
| μ | higher layer parameter is configured | layer parameters is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

The Capability 1 UE procession time for PDSCH is different depends on if ‘pos0’ is used (38.214 5.3), or for mapping Type A when certain conditions are met (38.211 7.4.1.1.2) and a second additional DMRS symbol (l₁) is on symbol 12 or not.

RRC configurations

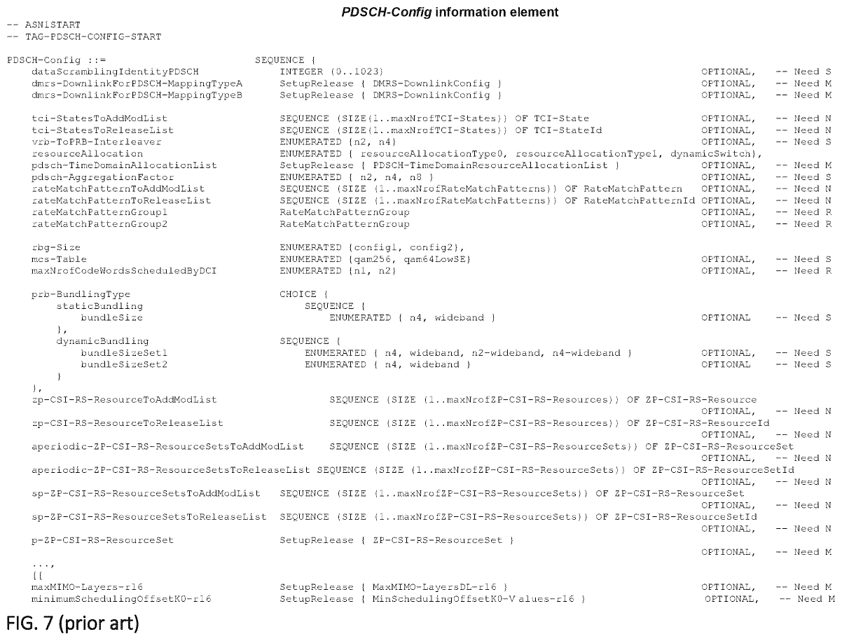

FIG. 7 shows a conventional PDSCH-Config Information Element (IE).

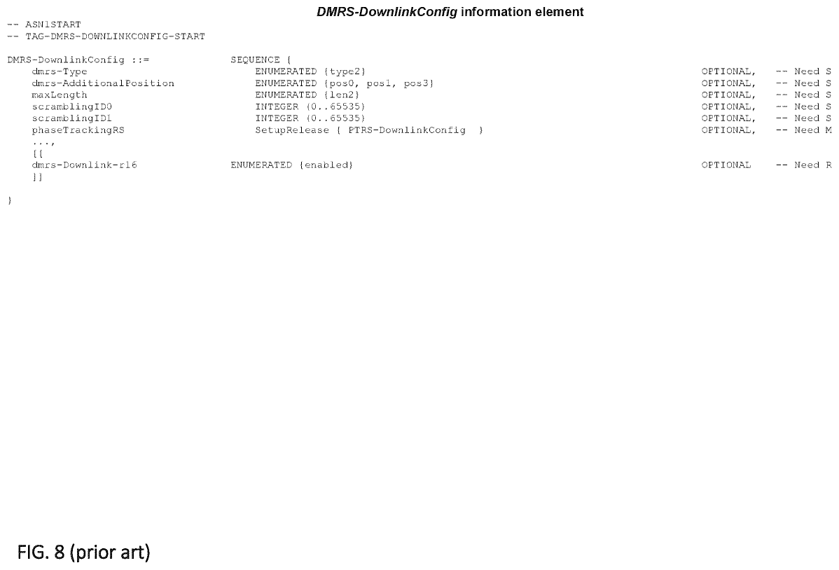

FIG. 8 shows a conventional DMRS-DownlinkConfig IE.

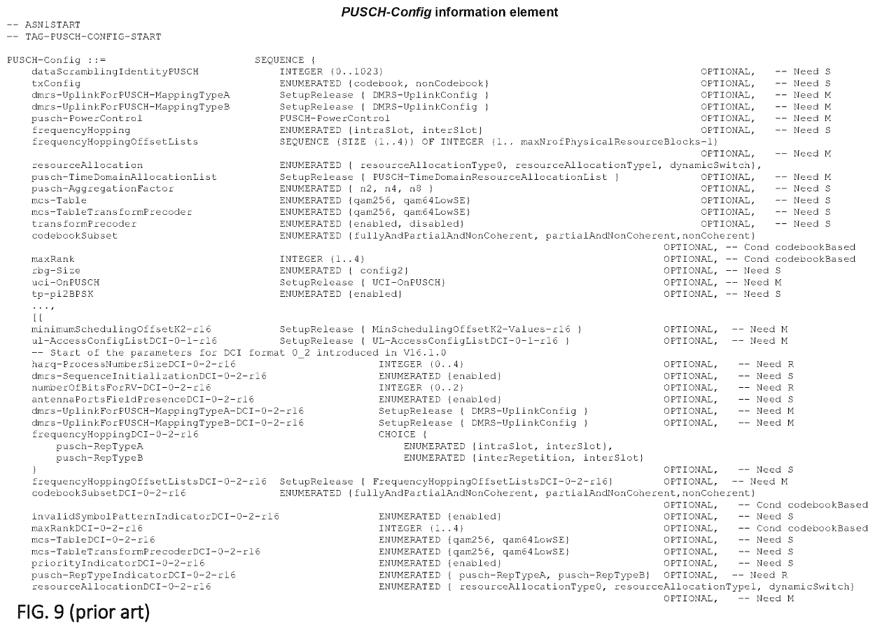

FIG. 9 shows a conventional PUSCH-Config IE.

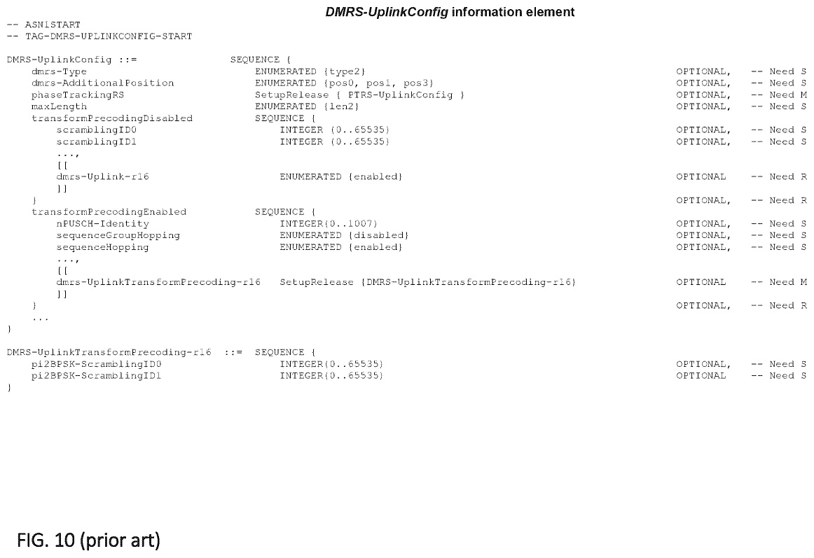

FIG. 10 shows a conventional DMRS-UplinkConfig IE.

TABLE 5.3-1
PDSCH processing time for PDSCH processing capability 1

| | PDSCH decoding time N₁ [symbols] | |
|---|---|---|
| | dmrs-AdditionalPosition = ‘pos0’ | |
| | in DMRS-DownlinkConfig in | dmrs-AdditionalPosition ≠ ‘pos0’ |
| | dmrs-DownlinkForPDSCH- | in DMRS-DownlinkConfig in any of |
| | MappingTypeA and dmrs- | dmrs-DownlinkForPDSCH- |
| | DownlinkForPDSCH-MappingTypeB | MappingTypeA, dmrs- |
| | if either higher layer parameter | DownlinkForPDSCH-MappingTypeB, |
| | is configured, and in dmrs- | dmrs-DownlinkForPDSCH- |
| | DownlinkForPDSCH-MappingTypeA- | MappingTypeA-DCI-1-2, dmrs- |
| | DCI-1-2 and dmrs-DownlinkForPDSCH- | DownlinkForPDSCH-MappingTypeB- |
| | MappingTypeB-DCI-1-2 if either | DCI-1-2, or if none of the higher |
| μ | higher layer parameter is configured | layer parameters is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

The Capability 1 UE procession time for PDSCH is different depends on if ‘pos0’ is used (38.214 5.3), or for mapping Type A when certain conditions are met (38.211 7.4.1.1.2) and a second additional DMRS symbol (11) is on symbol 12 or not.

### UE Indication of Dynamic DMRS Capability

Sending Indication of UE capability of supporting dynamic switching of number of additional DMRS symbols (or dynamically switching of DMRS time density). The UE capability might also include one or more of the following capabilities/information (where the following capabilities can for example be signaled per UE, or jointly/separately for DL and UL (e.g. PDSCH and PUSCH), jointly/separately for slot based scheduling and non-slot based scheduling (e.g. Type A scheduling and Type B scheduling in NR), jointly/separately per DMRS type (for example DMRS type 1, Type 2, extended Type 1 or extended type 2 in NR), max length of DMRS (i.e. the parameter MaxLength as specified in DMRS-UplinkConfig or DMRS-DownlinkConfig in TS 38.331, which describes the number of consecutive OFDM symbols a DMRS is occupying. In current NR, MaxLength can be either 1 or 2):
a. The maximum number of additional DMRS symbols that the UE can switch between, the value can for example be 2, 3, 4 or even larger for 6G. (the value can be indicated for MaxLength=1, for MaxLength=2, or for both MaxLength=1 and 2);
b. A list of supported number of additional DMRS symbols to dynamically switch between. (the values can be indicated for MaxLength=1, for MaxLength=2, or for both MaxLength=1 and 2):
c. The maximum DMRS density (for 6G, slot free scheduling might be introduced for one or several types of frequency bands, and in this case, the DMRS density in time might be used instead of number of DMRS symbols). The DMRS time density can for example be 1/2, where a DMRS is occupying every second time symbol, or 1/3 where a DMRS is occupying every third time symbol etc.:
d. A list of supported DMRS density (e.g. 1/2, 1/3, 1/4 etc):
e. Support of dynamic indication using MAC-CE:
f. Support of dynamic indication using DCI:
g. A list of DCI formats that can be used for the dynamic indication.

Receiving a configuration of a set of candidate number of additional DMRS symbols (e.g., dmrs-AdditionalPositions as specified in TS 38.331) or a set of candidate number of DMRS time densities:
a. The set of candidate number of additional DMRS symbols can for example be configured in a new field in DMRS-UplinkConfig or DMRS-DownlinkConfig in NR (as specified in TS 38.331).

Receiving indication in DCI or MAC-CE indicating one of the set of candidate number of additional DMRS symbols or one of the set of candidate number of DMRS time densities.
a. The indication is signaled in the TDRA field in NR, and an index of the additional positions is associated to a row in TDRA list:
   i. The TDRS list can be PUSCH or PDSCH.
b. A separate bitfield is used in a DCI to indicate which one of the set of candidate number of additional DMRS symbols or of the set of candidate number of DMRS time densities that he UE should assume:
   i. The size of the bitfield can be automatically adapted to the number of configured “candidate number of additional DMRS symbols” or the number of “candidate number of DMRS time densities” (for example, two “candidate number of additional DMRS symbols” is configured the size of the bitfield is equal to 1, and if 3-4 “candidate number of additional DMRS symbols” is configured the size of the bitfield is equal to 2. Hence the size of the bitfield is equal to: ceil (log 2 (“candidate number of additional DMRS symbols”)).
c. The DCI can be of format 1_1, 1_2 or 0)_1, 0_2, or a new DCI format in 6G.
d. The MAC-CE can be a new MAC-CE introduced for adapting the number of DMRS symbols or DMRS time density:
   i. The MAC-CE can include a bitfield used as a pointer to one of the configured candidate number of additional DMRS symbols or DMRS time densities.
   ii. The MAC-CE can include a bitfield used to directly indicate the number of additional DMRS symbols (e.g. if the codepoint of the bitfield is 0), the number of additional DMRS symbols in the slot is equal to 0, if the codepoint of the bitfield is 1, the number of additional DMRS symbols in the slot is equal to 1, etc):
   iii. The MAC-CE can include a bitfield that indicates if the indication of the number of DMRS symbols or DMRS time density should be applied to (e.g. only PDSCH, only PUSCH or both PDSCH and PUSCH)
   iv. The MAC-CE can include a bitfield that indicates for which DMRS types the indication of the number of DMRS symbols or DMRS time density should be applied to (e.g. one or more of DMRS Type 1, DMRS type 2, extended DMRS type 1, extended DMRS type 2).

When being scheduled with a PDSCH configured to support dynamically updated number of DMRS symbol, the UE aligns the processing time according to the additional position configuration of multiple positions that requires longest processing time.

The processing time can be a PDSCH capability 1 processing time.

Transmit PUSCH DMRS according to indicated additional DMRS positions in 3.

Receive PDSCH DMRS according to indicated additional DMRS positions in 3.

### Methods. Apparatuses, and Computer Program Products

Some aspects of the present disclosure contemplated herein will now be described more fully with reference to the accompanying drawings. Aspects are provided by way of example to convey the scope of the subject matter to those skilled in the art.

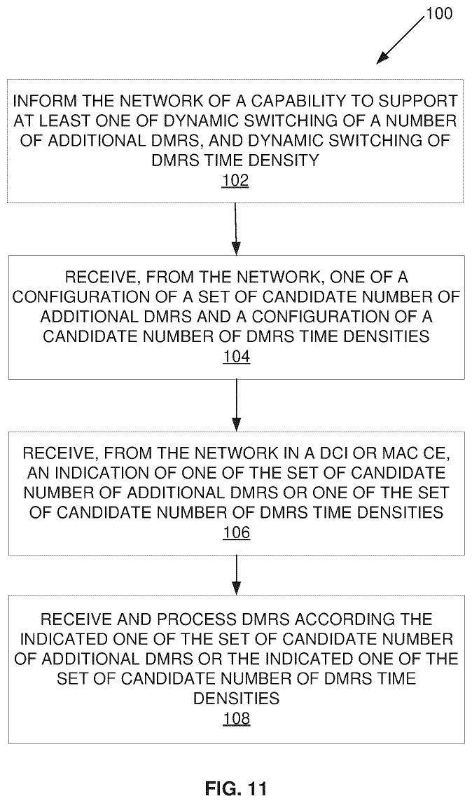

FIG. 11 depicts a method 100 in accordance with particular aspects. The method 100 is performed by a wireless device operative in a wireless communication network. The network is informed of a capability to support at least one of dynamic switching of a number of additional Demodulation Reference Symbols (DMRS), and dynamic switching of DMRS time density (block 102). One of a configuration of a set of candidate number of additional DMRS and a configuration of a candidate number of DMRS time densities is received from the network (block 104). An indication of one of the set of candidate number of additional DMRS or one of the set of candidate number of DMRS time densities is received from the network in a Downlink Control Information (DCI) or Media Access Control (MAC) Control Element (CE) (block 106). DMRS are received and processed according the indicated one of the set of candidate number of additional DMRS or the indicated one of the set of candidate number of DMRS time densities (block 108).

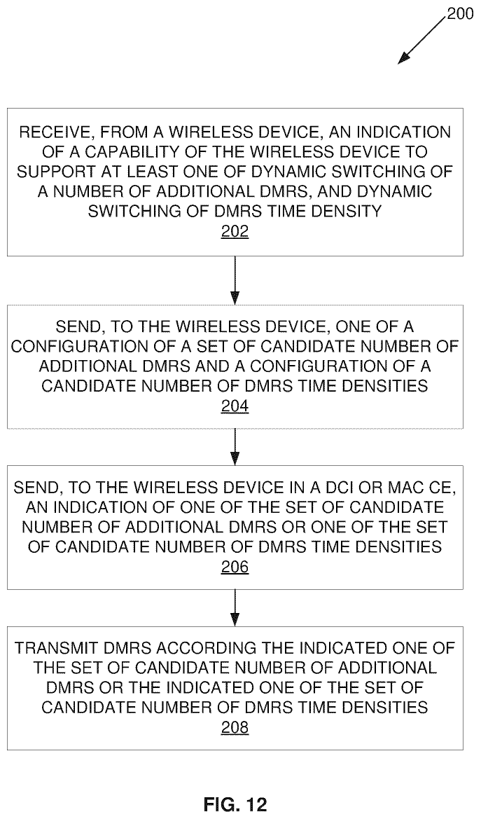

FIG. 12 depicts a method 200 in accordance with other particular aspects. The method 200 is performed by a base station operative in a wireless communication network. An indication of a capability of the wireless device to support at least one of dynamic switching of a number of additional Demodulation Reference Symbols (DMRS), and dynamic switching of DMRS time density is received from a wireless device (block 202). One of a configuration of a set of candidate number of additional DMRS and a configuration of a candidate number of DMRS time densities is sent to the wireless device (block 204). An indication of one of the set of candidate number of additional DMRS or one of the set of candidate number of DMRS time densities is sent to the wireless device in a Downlink Control Information (DCI) or Media Access Control (MAC) Control Element (CE) (block 206). DMRS are transmitted according the indicated one of the set of candidate number of additional DMRS or the indicated one of the set of candidate number of DMRS time densities (block 208).

Apparatuses described herein may perform the methods 100. 200 herein and any other processing by implementing any functional means, modules, units, or circuitry. In one aspect, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects. In aspects that employ memory, the memory stores program code that, when executed by the one or more processors, carries out the techniques described herein.

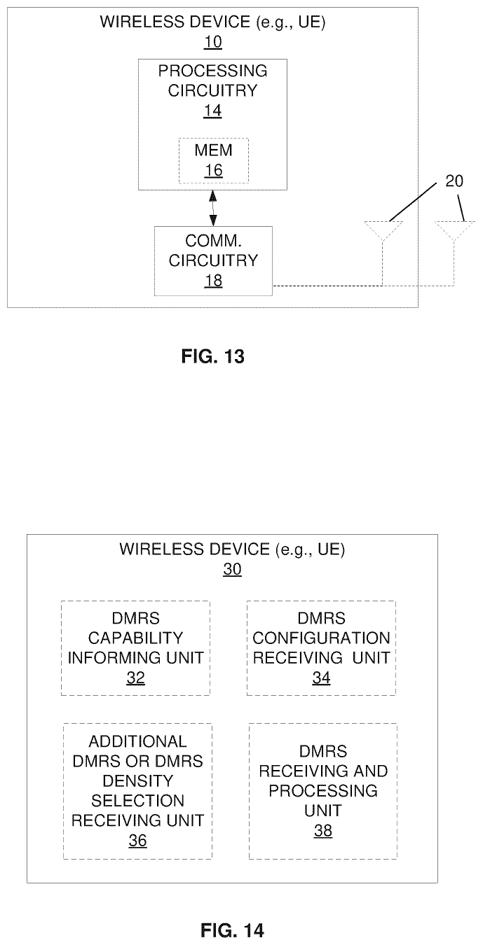

FIG. 13 for example illustrates a hardware block diagram of a wireless device 10 as implemented in accordance with one or more aspects. As shown, the wireless device 10 includes processing circuitry 14 and communication circuitry 18. The communication circuitry 18 (e.g., radio circuitry) is configured to transmit and/or receive information to and/or from one or more other nodes. e.g., via any communication technology. Such communication may occur via one or more antennas 20 that are either internal or external to the wireless device 10, as indicated by dashed lines. The processing circuitry 14 is configured to perform processing described above, such as by executing instructions stored in memory 16. The processing circuitry 14 in this regard may implement certain functional means, units, or modules.

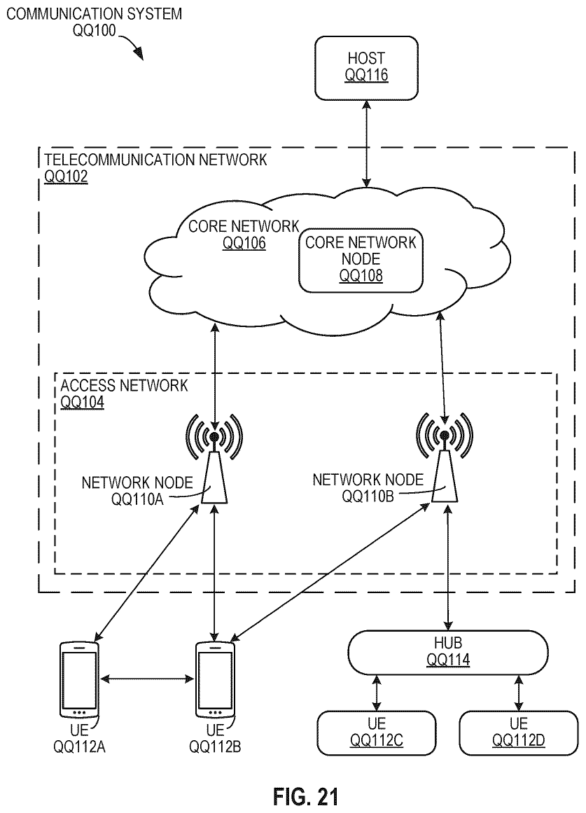

FIG. 14 illustrates a functional block diagram of a wireless device 30 in a wireless network according to still other aspects (for example, the wireless network shown in FIG. 21). As shown, the wireless device 30 implements various functional means, units, or modules, e.g., via the processing circuitry 14 in FIG. 13 and/or via software code. These functional means, units, or modules. e.g., for implementing the method(s) herein, include for instance: DMRS capability informing unit 32; DMRS configuration receiving unit 34; additional DMRS or DMRS density selection receiving unit 36; and DMRS receiving and processing unit 38.

DMRS capability informing unit 32 is configured to inform the network of a capability to support at least one of dynamic switching of a number of additional DMRS, and dynamic switching of DMRS time density. DMRS configuration receiving unit 34 is configured to receive, from the network, one of a configuration of a set of candidate number of additional DMRS and a configuration of a candidate number of DMRS time densities. Additional DMRS or

DMRS density selection receiving unit 36 is configured to receive, from the network in a DCI or MAC CE, an indication of one of the set of candidate number of additional DMRS or one of the set of candidate number of DMRS time densities. DMRS receiving and processing unit 38 is configured to receive and process DMRS according the indicated one of the set of candidate number of additional DMRS or the indicated one of the set of candidate number of DMRS time densities.

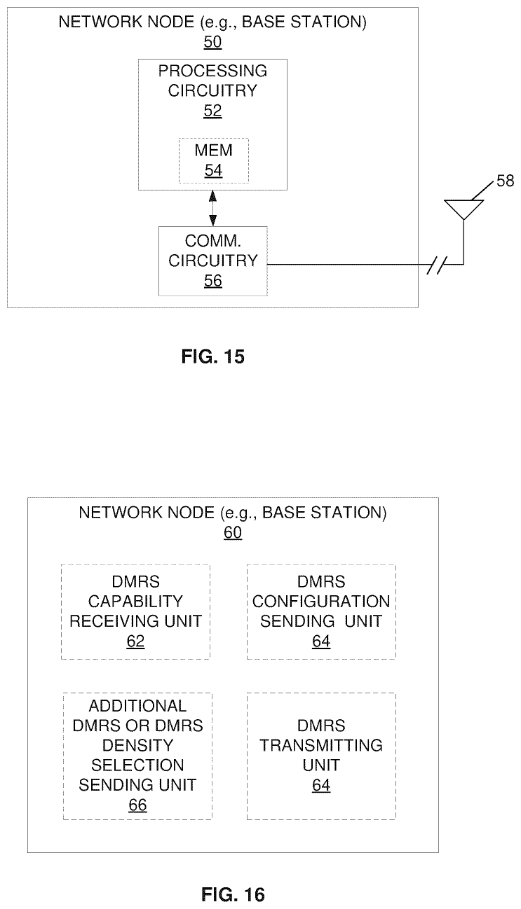

FIG. 15 illustrates a hardware block diagram of a network node 50 as implemented in accordance with one or more aspects. As shown, the network node 50 includes processing circuitry 52 and communication circuitry 56. The communication circuitry 56 is configured to transmit and/or receive information to and/or from one or more other nodes. e.g., via any communication technology. The network node 50 may function as a base station (e.g., eNB, gNB, etc.), any may wirelessly communication with a plurality of wireless devices 10 via one or more antennas 58. As indicated by the broken line, the antennas 58 may be located remotely from the network node 50, such as on a tower or building. The processing circuitry 14 is configured to perform processing described above, such as by executing instructions stored in memory 54. Although represented as being within the network node 50, those of skill in the art understand that some or all of the processing circuitry 14 may be implemented as virtualized servers in a data center, e.g., in the so-called cloud. The processing circuitry 14 in this regard may implement certain functional means, units, or modules.

FIG. 16 illustrates a functional block diagram of a network node 60 in a wireless network according to still other aspects (for example, the wireless network shown in FIG. 21). As shown, the network node 60 implements various functional means, units, or modules, e.g., via the processing circuitry 54 in FIG. 15 and/or via software code. These functional means, units, or modules, e.g., for implementing the method(s) herein, include for instance: DMRS capability receiving unit 62; DMRS configuration sending unit 64; additional DMRS or DMRS density selection sending unit 66; and DMRS transmitting unit 68.

DMRS capability receiving unit 62 is configured to receive from a wireless device, an indication of a capability of the wireless device to support at least one of dynamic switching of a number of additional DMRS, and dynamic switching of DMRS time density. DMRS configuration sending unit 64 is configured to send to the wireless device, one of a configuration of a set of candidate number of additional DMRS and a configuration of a candidate number of DMRS time densities. Additional DMRS or DMRS density selection transmitting unit 66 is configured to send to the wireless device in a DCI or MAC CE, an indication of one of the set of candidate number of additional DMRS or one of the set of candidate number of DMRS time densities. DMRS transmitting unit 68 is configured to transmit DMRS according the indicated one of the set of candidate number of additional DMRS or the indicated one of the set of candidate number of DMRS time densities.

Those skilled in the art will also appreciate that aspects herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects further include a carrier containing such a computer program. This carrier may comprise one of an electronic signal, optical signal, radio signal, or computer readable storage medium.

In this regard, aspects herein also include a computer program product stored on a non-transitory computer readable (storage or recording) medium and comprising instructions that, when executed by a processor of an apparatus, cause the apparatus to perform as described above.

Aspects further include a computer program product comprising program code portions for performing the steps of any of the aspects herein when the computer program product is executed by a computing device. This computer program product may be stored on a computer readable recording medium.

### RRC Configuration Implementation Examples

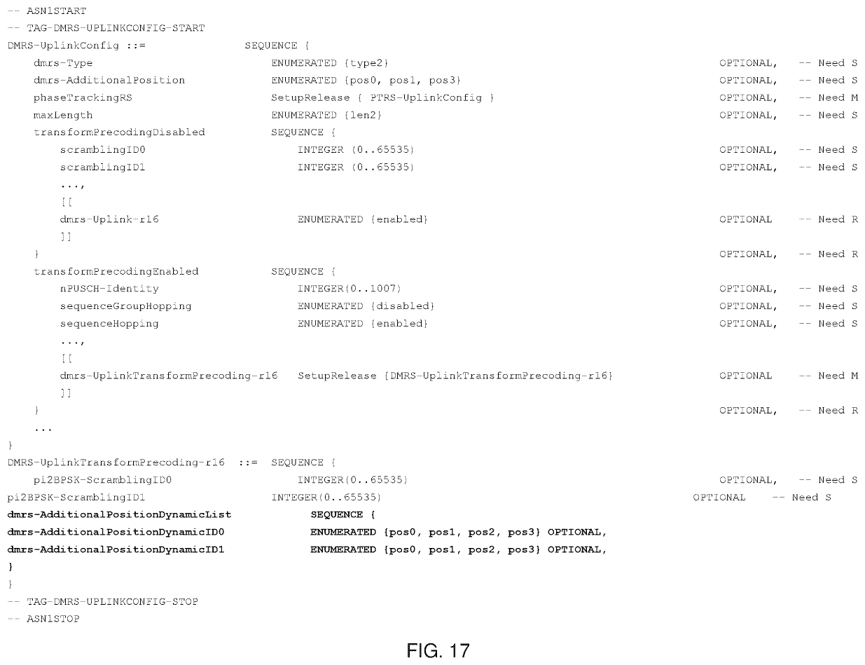

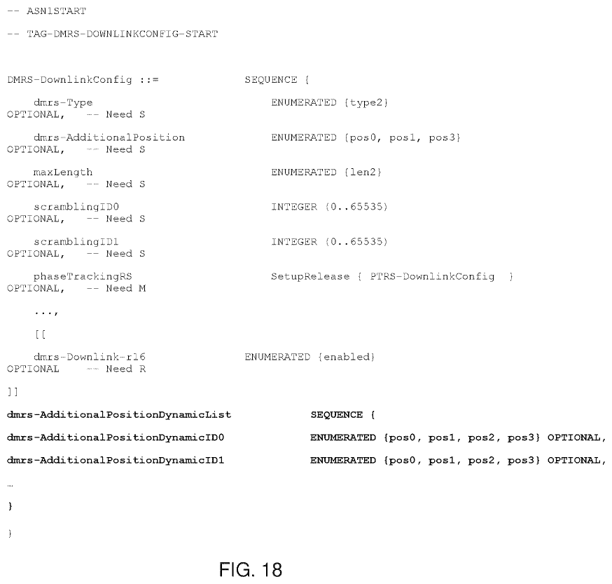

FIGS. 17-20 show a number of examples of how different aspects of the present disclosure can be introduced in NR using RRC configurations. In these examples, a list of additional number of DMRS symbols (e.g., “dmrs-AdditionalPositionDynamicID0”) is RRC configured in DMRS-UplinkConfig information element and DMRS-DownlinkConfig information element. A DCI or MAC-CE can then be used to indicate one of the additional number of DMRS symbols in the configured list.

FIG. 17 shows a DMRS-UplinkConfig IE.

FIG. 18 shows a DMRS-DownlinkConfig IE.

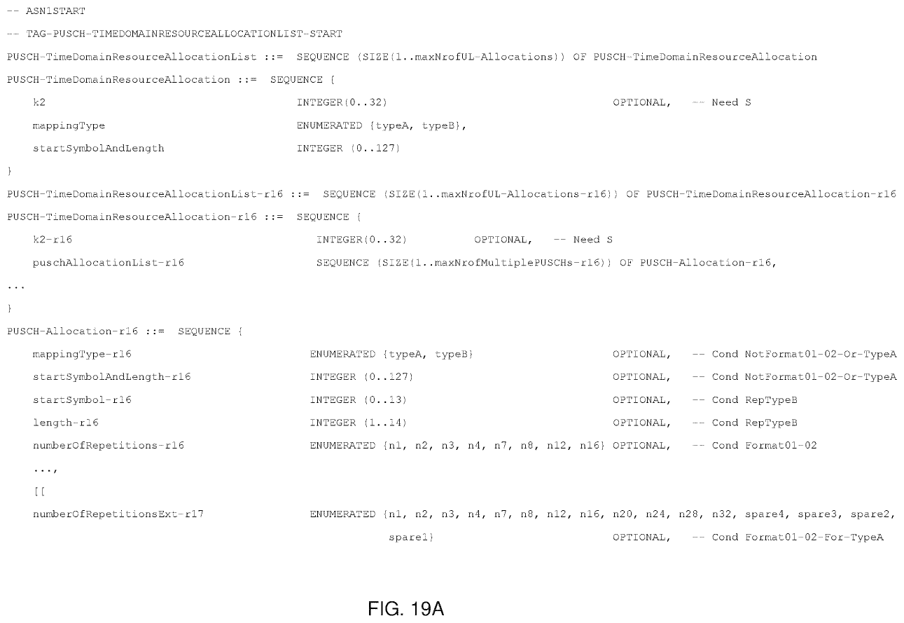

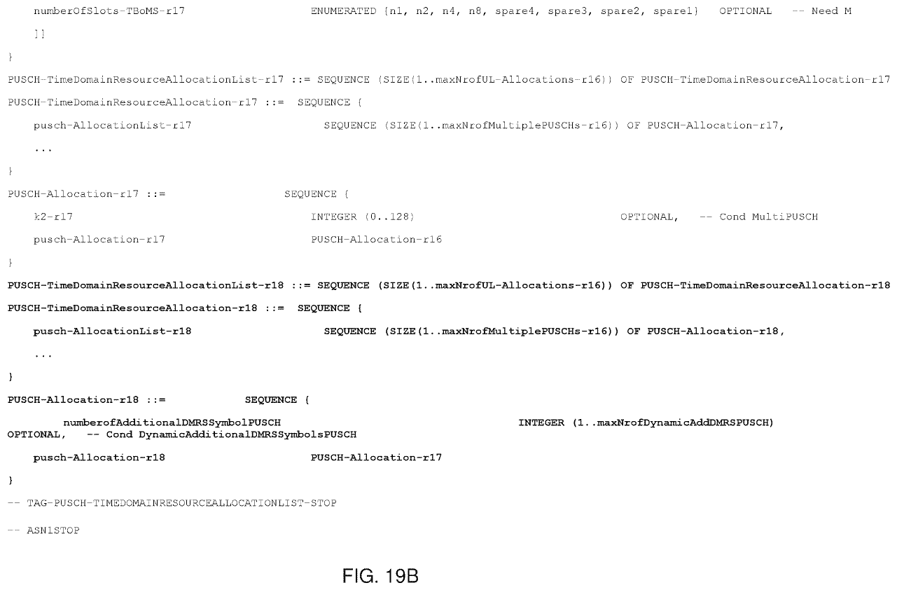

FIGS. 19A and 19B together show a PUSCH-TimeDomainResourceAllocation.

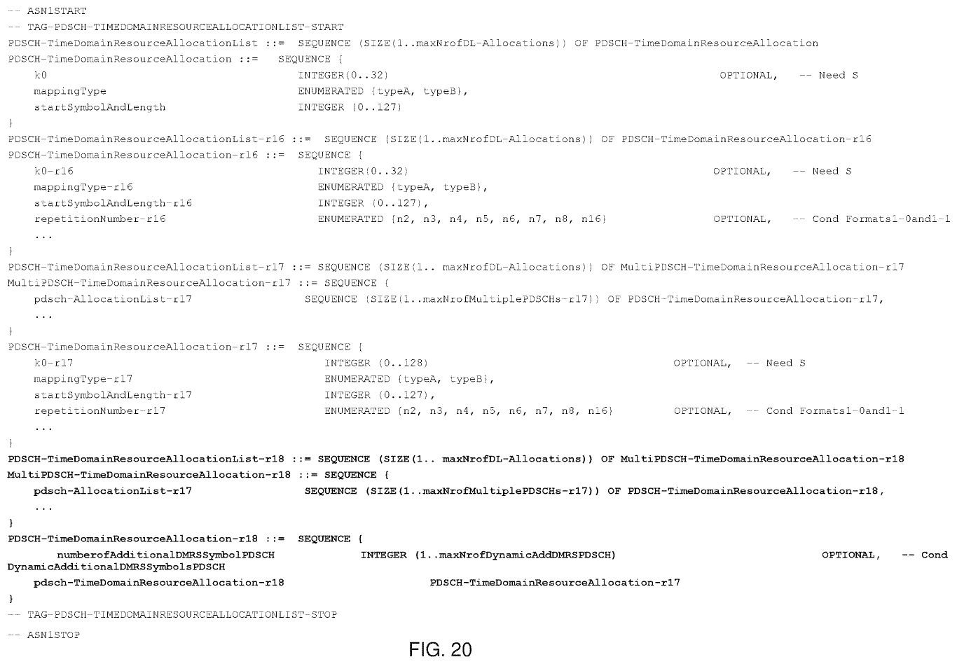

FIG. 20 shows a PDSCH-TimeDomainResourceAllocationList.

Aspects related to processing time of PDSCH

In Rel-15 to Rel-17, different additional position configuration will result in different PDSCH processing times.

In one embodiment, when dmrs-AdditionalPositionDynamicList is configured, or UE is configured to dynamically switch between additional DMRS symbols, the PDSCH processing time is aligned to the longest processing time among all the configured candidate number of additional DMRS symbols.

TABLE 5.3-1
PDSCH processing time for PDSCH processing capability 1

| | PDSCH decoding time N₁ [symbols] | |
|---|---|---|
| | dmrs-AdditionalPosition = ‘pos0’ | dmrs-AdditionalPosition ≠ ‘pos0’ |
| | in DMRS-DownlinkConfig in | or if dmrs-AdditionalPositionDynamicList |
| | dmrs-DownlinkForPDSCH-MappingTypeA | is provided in DMRS-DownlinkConfig in any |
| | and dmrs-DownlinkForPDSCH-MappingTypeB | of dmrs-DownlinkForPDSCH-MappingTypeA, |
| | if either higher layer parameter is configured, and | dmrs-DownlinkForPDSCH-MappingTypeB, |
| | in dmrs-DownlinkForPDSCH-MappingTypeA- | dmrs-DownlinkForPDSCH-Mapping TypeA- |
| | DCI-1-2 and dmrs-DownlinkForPDSCH- | DCI-1-2, dmrs-DownlinkForPDSCH- |
| | MappingTypeB-DCI-1-2 if either higher | MappingTypeB-DCI-1-2, or if none of the |
| μ | layer parameter is configured | higher layer parameters is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

Aspect related to configurable number of DMRS symbols

In one embodiment the UE has signaled support to dynamically switch between N number of additional DMRS symbols. To reduce the DCI overhead of indicating which of the N number of additional DMRS symbols the UE should assume for a PDSCH/PUSCH transmission, the UE can be RRC configured with only a subset of the supported candidate number of additional DMRS symbols. For example, assume that the UE signals in UE capability that it supports switching between 0,1,2,3 additional DMRS symbols, which would require a two-bit indication (since it is 4 candidate options to select from). Instead, the UE is RRC configured to only be able to dynamically switch between for example 0 and 1 additional DMRS symbols, which will reduce the DCI overhead from 2 bits to 1 bit.

### NETWORK DESCRIPTION AND OVER THE TOP (OTT) EMBODIMENTS

FIG. 21 shows an example of a communication system QQ100 in accordance with some aspects of the present disclosure.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes. UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC). Mobility Management Entity (MME). Home Subscriber Server (HSS). Access and Mobility Management Function (AMF). Session Management Function (SMF). Authentication Server Function (AUSF). Subscription Identifier De-concealing function (SIDF). Unified Data Management (UDM). Security Edge Protection Proxy (SEPP). Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 21 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax). Bluetooth. Z-Wave. Near Field Communication (NFC) ZigBee. LiFi. and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs. and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi. NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios. UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

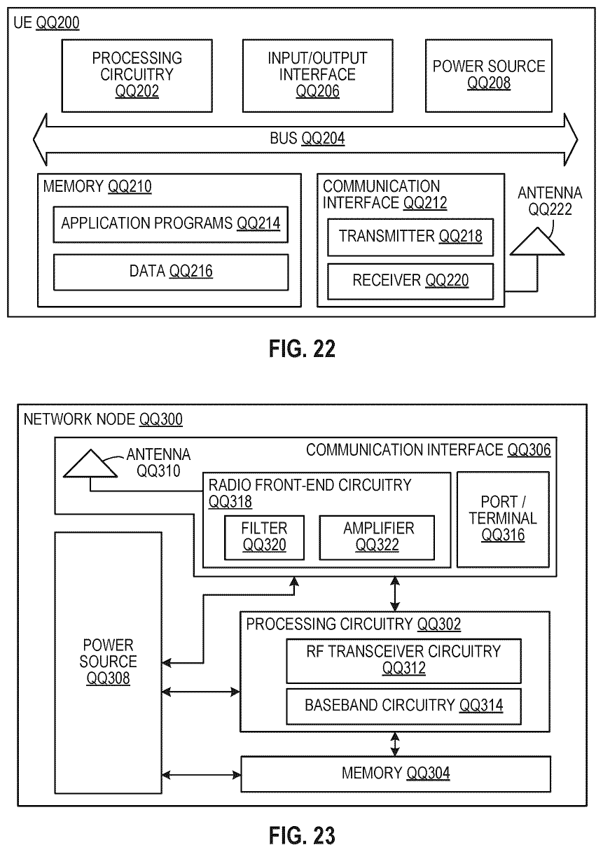

FIG. 22 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 22. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory. USB flash drive, external hard disk drive, thumb drive, pen drive, key drive, high-density digital versatile disc (HD-DVD) optical disc drive, internal hard disk drive. Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as SIM card.′ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication. Wi-Fi communication. LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11. Code Division Multiplexing Access (CDMA). Wideband Code Division Multiple Access (WCDMA), GSM. LTE. New Radio (NR). UMTS. WiMax. Ethernet, transmission control protocol/internet protocol (TCP/IP), synchronous optical networking (SONET). Asynchronous Transfer Mode (ATM). QUIC. Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 22.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 23 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations. Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes. Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM. WCDMA. LTE. NR. WiFi. Zigbee. Z-wave, LoRaWAN. Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 23 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

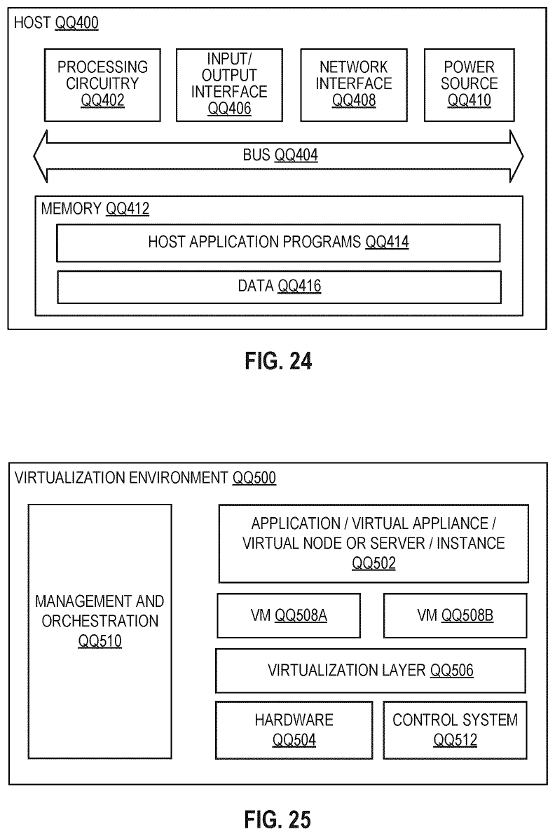

FIG. 24 is a block diagram of a host QQ400, which may be an embodiment of the host QQ116 of FIG. 21, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data. e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC). High Efficiency Video Coding (HEVC), Advanced Video Coding (AVC), MPEG. VP9) and audio codecs (e.g., FLAC. Advanced Audio Coding (AAC), MPEG. G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol. Real-Time Messaging Protocol (RTMP). Real-Time Streaming Protocol (RTSP). Dynamic Adaptive Streaming over HTTP (MPEG-DASH), etc.

FIG. 25 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node. UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

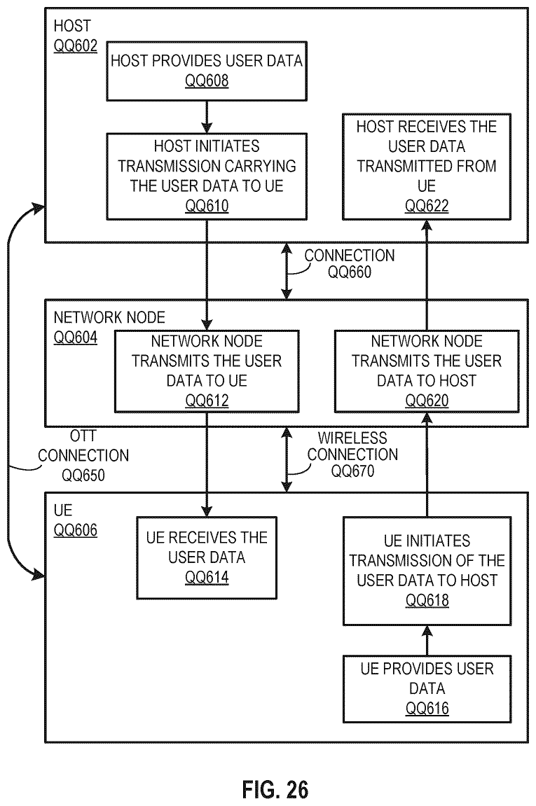

FIG. 26 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 21 and/or UE QQ200 of FIG. 22), network node (such as network node QQ110a of FIG. 21 and/or network node QQ300 of FIG. 23), and host (such as host QQ116 of FIG. 21 and/or host QQ400 of FIG. 24) discussed in the preceding paragraphs will now be described with reference to FIG. 26.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 21) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the quality of physical layer communicaitons and thereby provide benefits such as higher data rates, reduced errors, and reduced retransmissions and hence power savings.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio. VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606.

In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Aspects of the present disclosure present numerous advantages over the prior art, and may provide one or more of the following technical advantage(s). DL/UL performance is improved since the DMRS configuration can be quickly switched/optimized for the current usage (e.g., MU-MIMO or SU-MIMO). Additionally, depending on UE speed, dynamic switching can be done between different number of additional DMRS symbols, which helps achieve a good tradeoff between channel estimation performance and DMRS overhead.

### OTT EMBODIMENTS

### Group A Embodiments

Group A includes claims 1-20.

100. The method of any of the previous Group A embodiments, further comprising: providing user data; and forwarding the user data to a host via the transmission to the network node.

### Group B Embodiments

Group A includes claims 41-58.

101. The method of any of the previous Group B embodiments, further comprising: obtaining user data; and forwarding the user data to a host or a user equipment.

### Group C Embodiments

102. A user equipment for communicating with a network, comprising:
processing circuitry configured to perform any of the steps of any of the Group A embodiments; and
power supply circuitry configured to supply power to the processing circuitry.

103. A network node for communicating with user equipment, the network node comprising:
processing circuitry configured to perform any of the steps of any of the Group B

### Embodiments

power supply circuitry configured to supply power to the processing circuitry.

104. A user equipment (UE) for communicating with a network, the UE comprising:
an antenna configured to send and receive wireless signals:
radio front-end circuitry connected to the antenna and to processing circuitry, and configured to condition signals communicated between the antenna and the processing circuitry:
the processing circuitry being configured to perform any of the steps of any of the Group A embodiments:
an input interface connected to the processing circuitry and configured to allow input of information into the UE to be processed by the processing circuitry:
an output interface connected to the processing circuitry and configured to output information from the UE that has been processed by the processing circuitry; and
a battery connected to the processing circuitry and configured to supply power to the UE.

105. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

106. The host of the previous embodiment, wherein the cellular network further includes a network node configured to communicate with the UE to transmit the user data to the UE from the host.

107. The host of the previous two embodiments, wherein:
the processing circuitry of the host is configured to execute a host application, thereby providing the user data; and
the host application is configured to interact with a client application executing on the UE, the client application being associated with the host application.

108. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

109. The method of the previous embodiment, further comprising:
at the host, executing a host application associated with a client application executing on the UE to receive the user data from the UE.

110. The method of the previous embodiment, further comprising:
at the host, transmitting input data to the client application executing on the UE, the input data being provided by executing the host application,
wherein the user data is provided by the client application in response to the input data from the host application.

111. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

112. The host of the previous embodiment, wherein the cellular network further includes a network node configured to communicate with the UE to transmit the user data from the UE to the host.

113. The host of the previous two embodiments, wherein:
the processing circuitry of the host is configured to execute a host application, thereby providing the user data; and
the host application is configured to interact with a client application executing on the UE, the client application being associated with the host application.

114. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

115. The method of the previous embodiment, further comprising:
at the host, executing a host application associated with a client application executing on the UE to receive the user data from the UE.

116. The method of the previous embodiment, further comprising:
at the host, transmitting input data to the client application executing on the UE, the input data being provided by executing the host application,
wherein the user data is provided by the client application in response to the input data from the host application.

117. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

118. The host of the previous embodiment, wherein:
the processing circuitry of the host is configured to execute a host application that provides the user data; and
the UE comprises processing circuitry configured to execute a client application associated with the host application to receive the transmission of user data from the host.

119. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

120. The method of the previous embodiment, further comprising, at the network node, transmitting the user data provided by the host for the UE.

121. The method of any of the previous two embodiments, wherein the user data is provided at the host by executing a host application that interacts with a client application executing on the UE, the client application being associated with the host application.

122. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

123. The communication system of the previous embodiment, further comprising:
the network node; and/or
the user equipment.

124. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

125. The host of the previous two embodiments, wherein:
the processing circuitry of the host is configured to execute a host application, thereby providing the user data; and
the host application is configured to interact with a client application executing on the UE, the client application being associated with the host application.

126. The host of the any of the previous two embodiments, wherein the initiating receipt of the user data comprises requesting the user data.

127. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

128. The method of the previous embodiment, further comprising at the network node, transmitting the received user data to the host.

1-76. (canceled)

77. A method, performed by a wireless device operative in a wireless communication network, comprising:
informing the network of a capability to support at least one of dynamic switching of a number of additional Demodulation Reference Symbols (DMRS) and dynamic switching of DMRS time density, a maximum DMRS density that the wireless device supports, and that the wireless device supports dynamic indication of DMRS density using Media Access Control (MAC) Control Element (CE);
receiving, from the network, one of a configuration of a set of candidate number of additional DMRS and a configuration of a candidate number of DMRS time densities;
receiving, from the network in a Downlink Control Information (DCI) or MAC CE, an indication of one of the set of candidate number of additional DMRS or one of the set of candidate number of DMRS time densities; and
receiving and processing DMRS according the indicated one of the set of candidate number of additional DMRS or the indicated one of the set of candidate number of DMRS time densities.

78. The method of claim 77 wherein informing the network of a maximum DMRS density that the wireless device supports comprises informing the network that the wireless device supports dynamic indication of DMRS density using DCI.

79. The method of claim 77 wherein informing the network of a maximum DMRS density that the wireless device supports comprises providing the network a list of DCI formats that can be used for dynamic indication of DMRS density.

80. The method of claim 77 wherein receiving, from the network in a DCI, an indication of one of the set of candidate number of additional DMRS comprises receiving the indication in a Time Domain Resource Assignment (TDRA) field, and wherein an index of the additional positions is associated to a row in TDRA list.

81. The method of claim 77 wherein receiving, from the network in a MAC CE, an indication of one of the set of candidate number of additional DMRS or one of the set of candidate number of DMRS time densities comprises receiving the indication in a new MAC CE introduced for indicating the number of additional DMRS or the number of DMRS time densities, wherein the MAC CE includes a bitfield indicating that the indicated number of additional DMRS or number of DMRS time densities should be applied to only a Physical Downlink Shared Channel (PDSCH), only a Physical Uplink Shared Channel (PUSCH), or both PDSCH and PUSCH.

82. A wireless device operative in a wireless communication network, comprising:
communication circuitry configured to communicate with one or more network nodes; and
processing circuitry operatively connected to the communication circuitry and configured to
inform the network of a capability to support at least one of dynamic switching of a number of additional Demodulation Reference Symbols (DMRS) and dynamic switching of DMRS time density, a maximum DMRS density that the wireless device supports, and that the wireless device supports dynamic indication of DMRS density using Media Access Control (MAC) Control Element (CE);
receive, from the network, one of a configuration of a set of candidate number of additional DMRS and a configuration of a candidate number of DMRS time densities;
receive, from the network in a Downlink Control Information (DCI) or MAC CE, an indication of one of the set of candidate number of additional DMRS or one of the set of candidate number of DMRS time densities; and
receive and process DMRS according the indicated one of the set of candidate number of additional DMRS or the indicated one of the set of candidate number of DMRS time densities.

83. The wireless device of claim 82 wherein informing the network of a maximum DMRS density that the wireless device supports comprises informing the network that the wireless device supports dynamic indication of DMRS density using DCI.

84. The wireless device of claim 82 wherein informing the network of a maximum DMRS density that the wireless device supports comprises providing the network a list of DCI formats that can be used for dynamic indication of DMRS density.

85. The wireless device of claim 82 wherein the processing circuitry is configured to receive, from the network in a DCI, an indication of one of the set of candidate number of additional DMRS by receiving the indication in a Time Domain Resource Assignment (TDRA) field, and wherein an index of the additional positions is associated to a row in TDRA list.

86. The wireless device of claim 82 wherein the processing circuitry is configured to receive, from the network in a MAC CE, an indication of one of the set of candidate number of additional DMRS or one of the set of candidate number of DMRS time densities by receiving the indication in a new MAC CE introduced for indicating the number of additional DMRS or the number of DMRS time densities, wherein the MAC CE includes a bitfield indicating that the indicated number of additional DMRS or number of DMRS time densities should be applied to only a Physical Downlink Shared Channel (PDSCH), only a Physical Uplink Shared Channel (PUSCH), or both PDSCH and PUSCH.

87. A method, performed by a base station operative in a wireless communication network, comprising:
receiving, from a wireless device, an indication of a capability of the wireless device to support at least one of dynamic switching of a number of additional Demodulation Reference Symbols (DMRS) and dynamic switching of DMRS time density, a maximum DMRS density that the wireless device supports, and an indication that the wireless device supports dynamic indication of DMRS density using Media Access Control (MAC) Control Element (CE);
sending, to the wireless device, one of a configuration of a set of candidate number of additional DMRS and a configuration of a candidate number of DMRS time densities;
sending, to the wireless device in a Downlink Control Information (DCI) or MAC CE, an indication of one of the set of candidate number of additional DMRS or one of the set of candidate number of DMRS time densities; and
transmitting DMRS according the indicated one of the set of candidate number of additional DMRS or the indicated one of the set of candidate number of DMRS time densities.

88. The method of claim 87 wherein receiving, from a wireless device, an indication of a maximum DMRS density that the wireless device supports comprises receiving an indication that the wireless device supports dynamic indication of DMRS density using DCI.

89. The method of claim 87 wherein receiving, from a wireless device, an indication of a maximum DMRS density that the wireless device supports comprises receiving a list of DIC formats that can be used for dynamic indication of DMRS density.

90. The method of claim 87 wherein sending, to the wireless device in a DCI, an indication of one of the set of candidate number of additional DMRS comprises sending the indication in a Time Domain Resource Assignment (TDRA) field, and wherein an index of the additional positions is associated to a row in TDRA list.

91. The method of claim 87 wherein sending, to the wireless device in a MAC CE, an indication of one of the set of candidate number of additional DMRS or one of the set of candidate number of DMRS time densities comprises sending the indication in a new MAC CE introduced for indicating the number of additional DMRS or the number of DMRS time densities, wherein the MAC CE includes a bitfield indicating that the indicated number of additional DMRS or number of DMRS time densities should be applied to only a Physical Downlink Shared Channel (PDSCH), only a Physical Uplink Shared Channel (PUSCH), or both PDSCH and PUSCH.

92. A base station operative in a wireless communication network, comprising:
communication circuitry configured to communicate with one or more wireless devices; and
processing circuitry operatively connected to the communication circuitry and configured to
receive, from a wireless device, an indication of a capability of the wireless device to support at least one of dynamic switching of a number of additional Demodulation Reference Symbols (DMRS) and dynamic switching of DMRS time density, a maximum DMRS density that the wireless device supports, and an indication that the wireless device supports dynamic indication of DMRS density using Media Access Control (MAC) Control Element (CE);
send, to the wireless device, one of a configuration of a set of candidate number of additional DMRS and a configuration of a candidate number of DMRS time densities;
send, to the wireless device in a Downlink Control Information (DCI) or MAC CE, an indication of one of the set of candidate number of additional DMRS or one of the set of candidate number of DMRS time densities; and
transmit DMRS according the indicated one of the set of candidate number of additional DMRS or the indicated one of the set of candidate number of DMRS time densities.

93. The base station of claim 92 wherein the processing circuitry is configured to receive, from a wireless device, an indication of a maximum DMRS density that the wireless device supports by receiving an indication that the wireless device supports dynamic indication of DMRS density using DCI.

94. The base station of claim 92 wherein the processing circuitry is configured to receive, from a wireless device, an indication of a maximum DMRS density that the wireless device supports by receiving a list of DIC formats that can be used for dynamic indication of DMRS density.

95. The base station of claim 92 wherein the processing circuitry is configured to send, to the wireless device in a DCI, an indication of one of the set of candidate number of additional DMRS by sending the indication in a Time Domain Resource Assignment (TDRA) field, and wherein an index of the additional positions is associated to a row in TDRA list.

96. The base station of claim 92 wherein the processing circuitry is configured to send, to the wireless device in a MAC CE, an indication of one of the set of candidate number of additional DMRS or one of the set of candidate number of DMRS time densities by sending the indication in a new MAC CE introduced for indicating the number of additional DMRS or the number of DMRS time densities, wherein the MAC CE includes a bitfield indicating that the indicated number of additional DMRS or number of DMRS time densities should be applied to only a Physical Downlink Shared Channel (PDSCH), only a Physical Uplink Shared Channel (PUSCH), or both PDSCH and PUSCH.
